(19) United States
(12) Patent Application Publication
(10) Pub. No.: US 2022/0211567 A1
(43) Pub. Date: Jul. 7, 2022

(54) ELECTRIC POWER ASSIST DEVICE AND CONTROL DEVICE

(71) Applicant: TOYOTA JIDOSHA KABUSHIKI KAISHA, Toyota-shi (JP)

(72) Inventors: Yuka SHIRAIWA, Fuji-shi (JP); Hirotaka SAITO, Sunto-gun (JP); Yuma MATSUMOTO, Susono-shi (JP); Takahiro UCHIDA, Susono-shi (JP); Shuji MORIYAMA, Susono-shi (JP)

(73) Assignee: TOYOTA JIDOSHA KABUSHIKI KAISHA, Toyota-shi (JP)

(21) Appl. No.: 17/530,033

(22) Filed: Nov. 18, 2021

(30) Foreign Application Priority Data
Jan. 7, 2021 (JP) 2021-001727

(51) Int. Cl. A61H 3/00; A61H 1/02

(52) U.S. Cl. CPC A61H 3/00; A61H 2201/164; A61H 2201/1207; A61H 1/0266

(57) ABSTRACT

The electric power assist device includes a processor that includes hardware. The processor controls an operation amount and an operation speed of an actuator that assists a user in walking with the electric power assist device worn on the user, detects biometric information of the user, and controls the actuator such that the operation amount becomes larger than the operation amount in normal times but length of stride or the operation speed while walking is assisted becomes smaller than the length of stride or the operation speed in normal times, when determination is made that a physical condition of the user is poor based on the detected biometric information.

### CROSS-REFERENCE TO RELATED APPLICATION

This application claims priority to Japanese Patent Application No. 2021-001727 filed on Jan. 7, 2021, incorporated herein by reference in its entirety.

### BACKGROUND

### 1. Technical Field

The present disclosure relates to an electric power assist device and a control device.

### 2. Description of Related Art

Japanese Unexamined Patent Application Publication No. 2010-075658 (JP 2010-075658 A) discloses an electric power assist device that assists a user in walking with the electric power assist device worn on the body of the user. In a configuration described in JP 2010-075658 A, output of an actuator is changed according to a charging state of a battery. As a result, the output of the actuator decreases as a remaining battery level decreases, so that the user can recognize that the remaining battery level is low.

### SUMMARY

In the configuration described in JP 2010-075658 A, an operation amount of the electric power assist device is controlled such that length of stride while walking is assisted becomes constant. Therefore, even when the user is in poor physical condition, the length of stride is controlled to be the same as that in a normal condition, which may cause fatigue or pain to the user.

The present disclosure has been made in view of the above circumstances, and an object of the present disclosure is to provide an electric power assist device and a control device capable of controlling an actuator according to a physical condition of the user.

An electric power assist device according to the present disclosure includes a processor that includes hardware, and the processor controls an operation amount and an operation speed of an actuator that assists a user in walking with the electric power assist device worn on the user, detects biometric information of the user, and controls the actuator such that the operation amount becomes larger than the operation amount in normal times but length of stride or the operation speed while walking is assisted becomes smaller than the length of stride or the operation speed in normal times, when determination is made that a physical condition of the user is poor based on the detected biometric information.

A control device according to the present disclosure includes a processor that includes hardware, and the processor controls an operation amount and an operation speed of an electric power assist device that assists a user in walking with the electric power assist device worn on the user, detects biometric information of the user who wears the electric power assist device, and controls an actuator of the electric power assist device such that the operation amount becomes larger than the operation amount in normal times but length of stride or the operation speed while walking is assisted becomes smaller than the length of stride or the operation speed in normal times, when determination is made that a physical condition of the user is poor based on the detected biometric information.

According to the present disclosure, the actuator can be controlled according to the physical condition of the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view schematically showing an electric power assist device according to an embodiment;

FIG. 2 is a block diagram showing a functional block of the electric power assist device;

FIG. 3 is a flowchart showing a processing flow when an assist level is automatically set;

FIG. 4 is a flowchart showing a processing flow in a manual mode;

FIG. 5 is a flowchart showing a processing flow in a charge alarm; and

FIG. 6 is a diagram illustrating length of stride while walking is assisted.

### DETAILED DESCRIPTION OF EMBODIMENTS

Hereinafter, an electric power assist device and a control device according to an embodiment of the present disclosure will be specifically described with reference to the drawings. Further, the present disclosure is not limited to the embodiment described below.

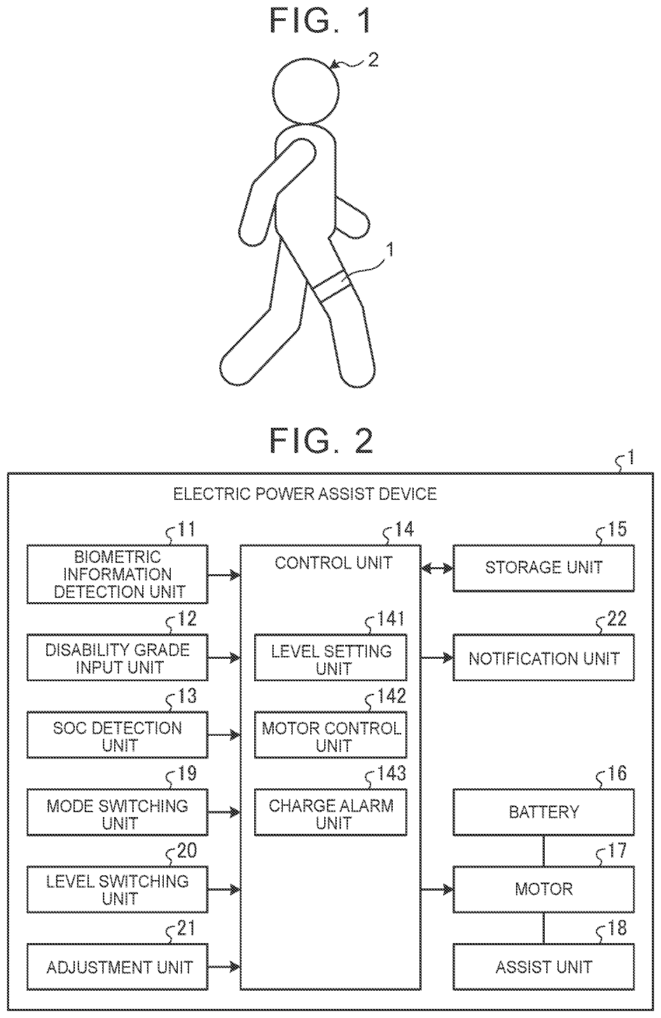

FIG. 1 is a schematic view schematically showing the electric power assist device according to the embodiment. An electric power assist device 1 is an electric power device that assists a user 2 in walking with the electric power assist device worn on the body of the user 2. The electric power assist device 1 is worn on the leg of the user 2 and electrically assists bending and stretching of the ankle joint. For example, as shown in FIG. 1, the electric power assist device 1 is worn on the thigh of the user 2 and electrically assists lifting and swinging of the leg. Alternatively, the electric power assist device 1 is worn on the knee of the user 2 and electrically assists bending and stretching of the knee. Alternatively, the electric power assist device 1 is worn on the ankle of the user 2 and electrically assists plantar flexion and dorsal flexion of the ankle. Then, the user 2 is assisted by the electric power assist device 1 in a state where the user 2 wears the electric power assist device 1, and length of stride is controlled.

FIG. 2 is a block diagram showing a functional block of the electric power assist device. As shown in FIG. 2, the electric power assist device 1 includes a biometric information detection unit 11, a disability grade input unit 12, a state of charge (SOC) detection unit 13, a control unit 14, a storage unit 15, a battery 16, a motor 17, an assist unit 18, a mode switching unit 19, a level switching unit 20, an adjustment unit 21, and a notification unit 22.

The biometric information detection unit 11 is a sensor that detects biometric information of the user 2. The biometric information detection unit 11 detects the pulse, the body temperature, the muscle mass, and the like of the user 2 as biometric information. The biometric information detection unit 11 can detect the biometric information of the user 2 in real time with the electric power assist device 1 worn on the user 2. The biometric information detected by the biometric information detection unit 11 is output to the control unit 14 and stored in the storage unit 15.

The disability grade input unit 12 is an input unit for inputting a disability grade of the user 2. The disability grade input unit 12 is operated by manual operation of the user 2, and the disability grade is input. Information on the disability grade input by operating the disability grade input unit 12 is output to the control unit 14.

The SOC detection unit 13 is a sensor that detects the state of charge (SOC) of the battery 16. The SOC represents a charging state of the battery 16. The SOC detection unit 13 can detect the current SOC.

The control unit 14 includes a processor and a memory. The processor is composed of a central processing unit (CPU), a digital signal processor (DSP), a field-programmable gate array (FPGA), and the like. The memory is a main storage device, and is composed of a random access memory (RAM), a read-only memory (ROM), and the like. The control unit 14 loads a program stored in the storage unit 15 into the work area of the memory (main storage device) and executes the program, and controls each component, etc. through the execution of the program such that the function that satisfies a predetermined purpose can be realized.

The storage unit 15 is composed of a recording medium such as erasable programmable ROM (EPROM). The storage unit 15 stores various programs executed by the control unit 14. For example, the storage unit 15 stores a program for executing electric power assist control that assists the user 2 in walking by the output of the motor 17. That is, the control unit 14 executes the electric power assist control that assists the user 2 in walking based on the program stored in the storage unit 15. The control unit 14 executes the electric power assist control, and drives the motor 17 using the electric power of the battery 16. When the motor 17 is driven, the assist unit 18 is operated by power output from the motor 17. At that time, the control unit 14 controls the output (torque and rotation speed) of the motor 17 to control the operation amount of the assist unit 18. The operation amount of the assist unit 18 is an assist amount for assisting the operation of the user 2.

The battery 16 is a storage battery that stores electric power to be supplied to the motor 17. The battery 16 is composed of a secondary battery such as a lithium ion battery. For example, the battery 16 is electrically connected to an external power source via a charging cable. Then, the electric power assist device 1 charges the battery 16 with the electric power supplied from the external power source under the control of the control unit 14. Further, since the battery 16 is electrically connected to the motor 17, the electric power charged in the battery 16 can be supplied to the motor 17.

The motor 17 is an electric motor that is driven using the electric power stored in the battery 16. The power output from the motor 17 is transmitted to the assist unit 18. For example, a member (power transmission member) for transmitting the power is provided between the rotation shaft of the motor 17 and the assist unit 18. The assist amount by the electric power assist device 1 changes depending on the output of the motor 17, that is, the operation amount and operation speed of the motor 17.

The assist unit 18 is a portion that applies the power of the motor 17 to the leg of the user 2, and is a member that is worn on the leg of the user 2. For example, the assist unit 18 is worn on the thigh of the user 2 and operates to assist lifting and swinging of the leg. In this case, the electric power assist device 1 shown in FIG. 1 represents a portion corresponding to the assist unit 18. Alternatively, the assist unit 18 is worn on the ankle of the user 2 and operates to assist plantar flexion and dorsal flexion of the ankle. Alternatively, the assist unit 18 is worn on the knee of the user 2 and operates to assist stretching and bending of the knee.

The mode switching unit 19 is a switch capable of switching between control modes by manual operation of the user 2. The control modes include an automatic mode and a manual mode. The automatic mode is a control mode in which an assist level is automatically set by the control unit 14. The manual mode is a control mode in which the assist level is set by the manual operation of the user 2. The user 2 can select the manual mode by manually operating the mode switching unit 19.

Further, the assist level is a level in which the assist amount by the electric power assist device 1 is set stepwise. The control unit 14 controls the operation amount and the operation speed of the motor 17 such that the assist amount corresponds to the assist level. The higher the assist level, the larger the assist amount by the electric power assist device 1. The lower the assist level, the smaller the assist amount by the electric power assist device 1.

The level switching unit 20 is an operation unit that can switch between assist levels by the manual operation of the user 2. The level switching unit 20 is configured to be included in an operation panel or the like. For example, when the manual mode is selected by manually operating the mode switching unit 19, the control unit 14 sets an assist level to the assist level selected by the level switching unit 20. Further, the control unit 14 can display the current assist level selected by the level switching unit 20 on the operation panel.

The adjustment unit 21 is an operation unit that can adjust the operation amount and the operation speed of the motor 17 by the manual operation of the user 2. The adjustment unit 21 is configured to be included in the operation panel or the like. Further, the adjustment unit 21 is a unit for adjusting the operation amount and the operation speed of the motor 17 without changing the assist level. That is, the adjustment unit 21 is used when the user 2 wishes to adjust the output of the motor 17 (the assist amount by the electric power assist device 1) although the user 2 does not wish to change the assist level. Therefore, when the operation of the adjustment unit 21 is received, the control unit 14 adjusts the output according to the operation of the adjustment unit 21 while maintaining the assist level.

Further, the control unit 14 includes a level setting unit 141, a motor control unit 142, and a charge alarm unit 143.

The level setting unit 141 sets the assist level according to the set control mode (the manual mode, the automatic mode). When the control mode is set to the manual mode, the level setting unit 141 sets an assist level to the assist level selected by the level switching unit 20. On the other hand, when the control mode is set to the automatic mode, the level setting unit 141 calculates an assist level based on the biometric information detected by the biometric information detection unit 11 and the information on the disability grade input by operating the disability grade input unit 12, and sets an assist level to the calculated assist level. In this case, the level setting unit 141 sets an assist level according to the disability grade. That is, the level setting unit 141 sets a high assist level when information on the disability grade indicating that the disability is severe is received, and sets a low assist level when information on the disability grade indicating that the disability is not severe is received. Then, the level setting unit 141 sets an assist level to the assist level according to the detected biometric information. When the biometric information indicating that the physical condition of the user 2 is normal is detected, the level setting unit 141 sets an assist level to the assist level in normal times. The assist level in normal times is, for example, an assist level set according to the disability grade, an assist level registered in the storage unit 15 by initial setting, or the like. Then, when the biometric information indicating that the physical condition of the user 2 is poor is detected, the level setting unit 141 sets an assist level to the assist level higher than that in normal times. For example, the level setting unit 141 sets a higher assist level by one step than the assist level set according to the disability grade information. This is because when the physical condition of the user 2 is poor, it is considered that the length of stride of the user 2 may be smaller than that in normal times, and the user 2 may wish larger assist amount by the electric power assist device 1 than that in normal times.

The motor control unit 142 controls the output of the motor 17 according to the assist level. For example, when the assist level is set to be high, the motor control unit 142 controls the output (the operation amount and the operation speed) of the motor 17 such that the output of the motor 17 becomes large, which leads to a larger assist amount. For example, when the assist level is set to be low, the motor control unit 142 controls the output (the operation amount and the operation speed) of the motor 17 such that the output of the motor 17 becomes small, which leads to a smaller assist amount.

Further, the motor control unit 142 controls the output of the motor 17 according to the operation of the adjustment unit 21. For example, when the adjustment unit 21 is operated such that assist amount becomes large, the motor control unit 142 controls the output (the operation amount and the operation speed) of the motor 17 such that the output of the motor 17 becomes large. For example, when the adjustment unit 21 is operated such that assist amount becomes small, the motor control unit 142 controls the output (the operation amount and the operation speed) of the motor 17 such that the output of the motor 17 becomes small.

The charge alarm unit 143 notifies that the SOC of the battery 16 has been reduced below a predetermined value. The charge alarm unit 143 sets a threshold value of the SOC according to the disability grade and the assist level. For example, when the disability grade input by operating the disability grade input unit 12 is high, the assist amount becomes large and the power consumption of the battery 16 becomes large, so that the charge alarm unit 143 sets the threshold value of the SOC to a high value. That is, the charge alarm unit 143 sets the threshold value of the SOC to a high value when an assist level in which the power consumption of the battery 16 increases is set. Then, when the SOC of the battery 16 is reduced below the threshold value, the charge alarm unit 143 uses the notification unit 22 to generate an alarm by sound, light, or vibration. The notification unit 22 is composed of a speaker, a lamp, a vibration unit, and the like. The notification unit 22 notifies the user 2 of the charging state of the battery 16. Therefore, the user 2 can recognize that the battery 16 needs to be charged in the near future by receiving the notification generated by the notification unit 22.

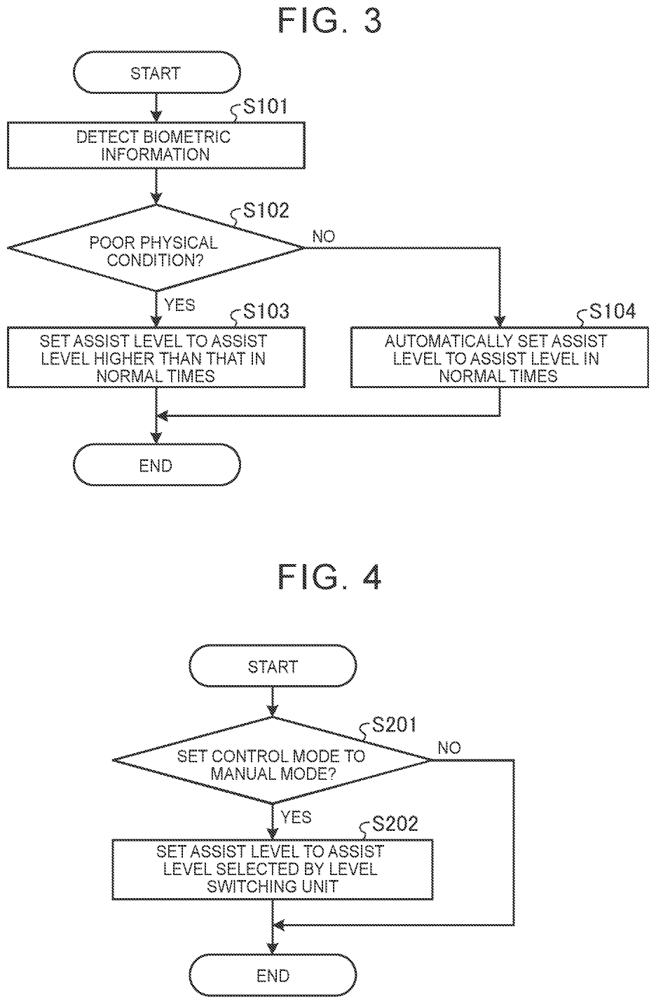

FIG. 3 is a flowchart showing a processing flow when the assist level is automatically set. The control shown in FIG. 3 is executed when the control mode is set to the automatic mode.

The biometric information detection unit 11 detects biometric information of the user 2 (step S101). In step S101, the biometric information detection unit 11 detects, as the current biometric information, the pulse, the body temperature, the muscle mass, and the like of the user 2 who wears the electric power assist device 1. Step S101 is performed in a case where the user 2 starts to use the electric power assist device 1 at the time when the user 2 wears the electric power assist device 1 and in a case where a predetermined time has elapsed since the user 2 wears the electric power assist device 1.

The control unit 14 determines whether the user 2 is in poor physical condition based on the biometric information detected by the biometric information detection unit 11 (step S102). In step S102, it is determined whether the physical condition of the user 2 is normal or poor by comparing the detected biometric information of the user 2 with information on the physical condition of the user 2 in normal times stored in the storage unit 15 in advance. The information on the physical condition in normal times may be information based on a preset value, or may be information obtained by accumulating the biometric information detected by the biometric information detection unit 11. When the accumulated data is used, an average value or the like of the accumulated data as the biometric information is compared with an actual measurement value detected by the biometric information detection unit 11. When there is a large difference between the average value and the actual measurement value, it is possible to determine that the physical condition of the user 2 is poor. Step S102 is performed in a case where the user 2 starts to use the electric power assist device 1 at the time when the user 2 wears the electric power assist device 1 and in a case where a predetermined time has elapsed since the user 2 wears the electric power assist device 1. The control unit 14 is configured to be able to determine whether the predetermined time has elapsed since the user 2 wears the electric power assist device 1.

When it is determined that the physical condition of the user 2 is poor (step S102: Yes), the control unit 14 automatically sets an assist level to the assist level higher than that in normal times (step S103). In step S103, the level setting unit 141 sets the assist level to a value higher than that in normal times. When the process of step S103 is executed, this control routine ends.

When it is determined that the physical condition of the user 2 is as usual (step S102: No), the control unit 14 automatically sets an assist level to the assist level in normal times (step S104). In step S104, the level setting unit 141 sets the assist level to a value in normal times. When the process of step S104 is executed, this control routine ends.

For example, when the control shown in FIG. 3 is executed at the time when the user 2 wears the electric power assist device 1, the initial assist level is set by the processes of steps S103 and S104. That is, when the user 2 will try to walk, the assist level is initially set before the user 2 starts to walk. Alternatively, when the control shown in FIG. 3 is executed while the user 2 is using the electric power assist device 1, the assist level is automatically changed by the processes of steps S103 and S104. Specifically, when the physical condition of the user 2 becomes worse than in normal times during walking, the assist level is automatically changed according to the poor physical condition of the user 2. As a result, the assist amount can be adjusted according to the physical condition of the user 2. When the physical condition of the user 2 that has become worse returns to be normal, the control unit 14 may automatically change the assist level according to the normal physical condition of the user 2.

FIG. 4 is a flowchart showing a processing flow in the manual mode. The control shown in FIG. 4 is executed by the control unit 14.

The control unit 14 determines whether to set the control mode to the manual mode (step S201). In step S201, it is determined whether the manual mode is selected by the operation of the mode switching unit 19. For example, it is determined whether a request for switching from the automatic mode to the manual mode has been received.

When the control mode is set to the manual mode (step S201: Yes), the control unit 14 sets an assist level to the assist level selected by the level switching unit 20 (step S202). In step S202, the assist level selected by the level switching unit 20 is set such that the assist level selected by the user 2 is set. For example, when the control mode is switched from the automatic mode to the manual mode, the level setting unit 141 changes the assist level set in the automatic mode to the assist level selected by the level switching unit 20. When the process of step S202 is executed, this control routine ends.

On the other hand, when the control mode is not set to the manual mode (step S201: No), this control routine ends.

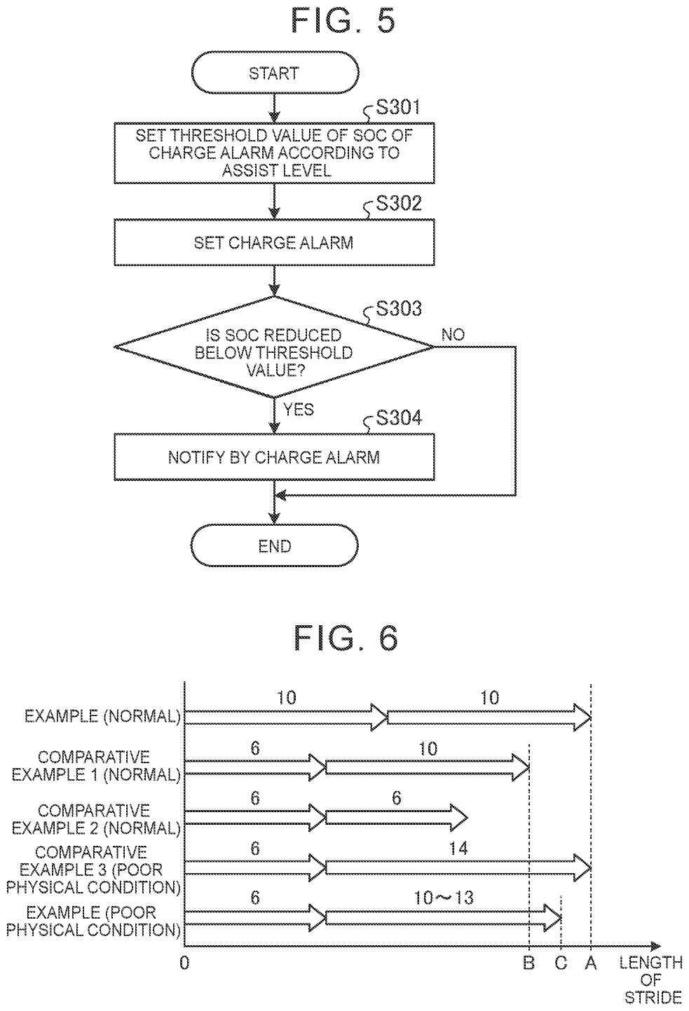

FIG. 5 is a flowchart showing a processing flow in the charge alarm. The control shown in FIG. 5 is executed by the control unit 14.

The control unit 14 sets the threshold value of the SOC of the charge alarm according to the assist level (step S301). In step S301, when the control mode is set to the automatic mode, the threshold value of the SOC is set according to the assist level automatically set by the level setting unit 141. When the control mode is set to the manual mode, the threshold value of the SOC is set according to the assist level selected by the manual operation of the level switching unit 20. The set threshold value of the SOC is stored in the storage unit 15.

Further, the control unit 14 sets a charge alarm based on the set threshold value of the SOC (step S302). In step S302, the charge alarm is set.

Then, the control unit 14 determines whether the SOC of the battery 16 is reduced below the threshold value (step S303). In step S303, it is determined whether the current SOC detected by the SOC detection unit 13 is reduced below the threshold value set in step S301.

When the SOC of the battery 16 is reduced below the threshold value (step S303: Yes), the control unit 14 activates the charge alarm to notify that the SOC of the battery 16 is reduced (step S304). In step S304, the notification unit 23 performs notification by sound, light, vibration, or the like under the control of the control unit 14. When the process of step S304 is executed, this control routine ends.

On the other hand, when the SOC of the battery 16 is not reduced below the threshold value (step S303: No), this control routine ends.

FIG. 6 is a diagram illustrating length of stride while waking is assisted. In FIG. 6, a case where the physical condition of the user 2 is as usual is described as “normal”, and a case where the physical condition of the user 2 is poor is described as “poor physical condition”. Further, FIG. 6 illustrates, as examples, Example, Comparative Example 1, Comparative Example 2, and Comparative Example 3.

As shown in FIG. 6, in Example, in a case where the physical condition of the user 2 is as usual (normal), the assist amount is controlled to “10” by the electric power assist device 1 when the movement amount of the user 2 becomes “10”. The length of stride in this case is a length of stride while waking is assisted in normal times for the user 2. That is, length of stride A when the assist amount becomes “10” and the user 2 recognizes that the movement amount is “10” is recognized by the user 2 as the assist level in normal times, which does not cause discomfort for the user 2.

Comparative Example 1, Comparative Example 2, and Comparative Example 3 each illustrates, as an example, a configuration in which the poor physical condition of the user 2 cannot be detected. In Comparative Example 1, although the movement amount of the user 2 is “6” that is smaller than that in normal times because the user 2 is in poor physical condition, the assist amount is “10” because the electric power assist device cannot determine the physical condition of the user 2. Length of stride while waking is assisted according to Comparative Example 1 is length of stride B smaller than the length of stride A in normal times. In Comparative Example 1, there is a difference between the movement amount of the user 2 and the assist amount by the electric power assist device. Therefore, in Comparative Example 2, when the movement amount of the user 2 becomes “6”, the assist amount is also controlled to be “6”. However, since the physical condition of the user 2 cannot be also determined in Comparative Example 2, the length of stride becomes considerably smaller than the length of stride A in normal times for the user 2 whose physical condition is normal, which results in discomfort for the user 2. The deviation of the length of stride in Comparative Example 2 from the length of stride A is the same as that in Comparative Example 1. Therefore, Comparative Example 3 is configured to assist the user 2 such that a length of stride is set to be the same as that in normal times according to the movement amount of the user 2. In Comparative Example 3, when the movement amount of the user 2 is “6”, the assist amount is controlled to be “14” such that the length of stride is set to be the length of stride A in normal times. However, in this case, when the user 2 is in poor physical condition and the movement amount is “6” smaller than that in normal times, the assist amount is “14” and the length of stride is the same as the length of stride A in normal times, which may result in discomfort and fatigue for the user 2. Then, if the user 2 is in poor physical condition, it is considered that the user 2 wishes a larger assist amount than in normal times but wishes smaller length of stride than in normal times.

In Example, the output of the motor 17 can be adjusted according to the physical condition of the user 2. Therefore, in Example, when it is detected that the physical condition of the user 2 is poor, the assist amount is controlled to be “10 to 13” when the movement amount of the user 2 becomes “6”. That is, when the user 2 is in poor physical condition, the electric power assist device 1 controls the assist amount such that the assist amount becomes larger than that in normal times, and controls the length of stride such that the length of stride while waking is assisted becomes smaller than that in normal times. As shown in FIG. 6, length of stride C while walking is assisted according to Example when the user 2 is in poor physical condition is smaller than the length of stride A in normal times and larger than the length of stride B while walking is assisted according to Comparative Example 1. As described above, according to Example, when the user 2 is in poor physical condition, it is possible to realize, as the user 2 wishes, a larger assist amount and smaller length of stride than those in normal times.

As described above, according to the embodiment, the output of the motor 17 can be controlled according to the physical condition of the user 2.

The electric power assist device 1 is not limited to include the motor 17, and may include other actuators. That is, a type of actuators is not particularly limited as long as the actuator is an electric actuator that consumes electric power of the battery 16. For example, the electric power assist device 1 provided with an electric air pump as an actuator may be used. In this case, the electric air pump and the assist unit 18 are connected via a tube.

Further effects and modifications can be easily derived by those skilled in the art. The broader aspects of the present disclosure are not limited to the particular details and representative embodiments shown and described above. Accordingly, various modifications may be made without departing from the spirit or scope of the general inventive concept as defined by the appended claims and their equivalents.

What is claimed is:

1. An electric power assist device comprising a processor that includes hardware, wherein the processor:
controls an operation amount and an operation speed of an actuator that assists a user in walking with the electric power assist device worn on the user;
detects biometric information of the user; and
controls the actuator such that the operation amount becomes larger than the operation amount in normal times but length of stride or the operation speed while walking is assisted becomes smaller than the length of stride or the operation speed in normal times, when determination is made that a physical condition of the user is poor based on the detected biometric information.

2. The electric power assist device according to claim 1, wherein the processor:
sets an assist level based on the detected biometric information;
controls the actuator according to the set assist level;
increases the operation amount as the assist level is high; and
reduces the operation amount as the assist level is low.

3. The electric power assist device according to claim 2, wherein the processor controls the actuator such that the assist level is set to be higher than the assist level in normal times but the length of stride or the operation speed while the walking is assisted becomes smaller than the length of stride or the operation speed in normal times, when determination is made that the physical condition of the user is poor based on the detected biometric information.

4. The electric power assist device according to claim 3, wherein the processor switches control modes between an automatic mode in which the assist level is automatically set based on the detected biometric information and a manual mode in which the assist level is set by manual operation of the user.

5. The electric power assist device according to claim 4, further comprising a mode switching unit that is able to switch between the automatic mode and the manual mode by the manual operation of the user, wherein the processor sets the control modes to the manual mode when the user selects the manual mode by operating the mode switching unit.

6. The electric power assist device according to claim 5, further comprising a level switching unit that is able to switch the assist level by the manual operation of the user, wherein the processor sets an assist level to an assist level selected by operating the level switching unit when the user selects the manual mode by operating the mode switching unit.

7. The electric power assist device according to claim 6, wherein the processor changes the assist level set in the automatic mode to the assist level selected by operating the level switching unit when the user selects the manual mode by operating the mode switching unit in a state in which the automatic mode is set.

8. The electric power assist device according to claim 7, further comprising:
a battery that stores electric power to be supplied to the actuator;
an SOC detection unit that detects an SOC of the battery; and
a notification unit that notifies a charging state of the battery, wherein the processor:
is able to set a charge alarm that notifies the charging state using the notification unit when the detected SOC is lower than a threshold value; and
sets the threshold value to be higher as the assist level is high.

9. The electric power assist device according to claim 8, further comprising a grade input unit that is able to set a disability grade of the user by the manual operation of the user, wherein the processor sets the threshold value according to the disability grade set by the grade input unit.

10. The electric power assist device according to claim 4, further comprising an adjustment unit that is able to adjust the operation amount by the manual operation of the user, wherein the processor changes to the operation amount according to the adjustment unit without changing the assist level when the adjustment unit is operated in a state in which the automatic mode is set.

11. A control device comprising a processor that includes hardware, wherein the processor:
controls an operation amount and an operation speed of an electric power assist device that assists a user in walking with the electric power assist device worn on the user;
detects biometric information of the user who wears the electric power assist device; and
controls an actuator of the electric power assist device such that the operation amount becomes larger than the operation amount in normal times but length of stride or the operation speed while walking is assisted becomes smaller than the length of stride or the operation speed in normal times, when determination is made that a physical condition of the user is poor based on the detected biometric information.

12. The control device according to claim 11, wherein the processor:
sets an assist level based on the detected biometric information;
controls the actuator according to the set assist level;
increases the operation amount as the assist level is high; and
reduces the operation amount as the assist level is low.

13. The control device according to claim 12, wherein the processor controls the actuator such that the assist level is set to be higher than the assist level in normal times but the length of stride or the operation speed while the walking is assisted becomes smaller than the length of stride or the operation speed in normal times, when determination is made that the physical condition of the user is poor based on the detected biometric information.

14. The control device according to claim 13, wherein the processor switches control modes between an automatic mode in which the assist level is automatically set based on the detected biometric information and a manual mode in which the assist level is set by manual operation of the user.

15. The control device according to claim 14, wherein:
the electric power assist device further includes a mode switching unit that is able to switch between the automatic mode and the manual mode by the manual operation of the user; and
the processor sets the control modes to the manual mode when the user selects the manual mode by operating the mode switching unit.

16. The control device according to claim 15, wherein:
the electric power assist device further includes a level switching unit that is able to switch the assist level by the manual operation of the user; and
the processor sets an assist level to an assist level selected by operating the level switching unit when the user selects the manual mode by operating the mode switching unit.

17. The control device according to claim 16, wherein the processor changes the assist level set in the automatic mode to the assist level selected by operating the level switching unit when the user selects the manual mode by operating the mode switching unit in a state in which the automatic mode is set.

18. The control device according to claim 17, wherein the electric power assist device further includes a battery that stores electric power to be supplied to the actuator,
an SOC detection unit that detects an SOC of the battery, and
a notification unit that notifies a charging state of the battery; and the processor
is able to set a charge alarm that notifies the charging state using the notification unit when the detected SOC is lower than a threshold value, and
sets the threshold value to be higher as the assist level is high.

19. The control device according to claim 18, wherein:
the electric power assist device further includes a grade input unit that is able to set a disability grade of the user by the manual operation of the user; and
the processor sets the threshold value according to the disability grade set by the grade input unit.

20. The control device according to claim 14, wherein:
the electric power assist device further includes an adjustment unit that is able to adjust the operation amount by the manual operation of the user; and
the processor changes to the operation amount according to the adjustment unit without changing the assist level when the adjustment unit is operated in a state in which the automatic mode is set.
